(19) United States
(12) Patent Application Publication
(10) Pub. No.: US 2026/0370507 A1
(43) Pub. Date: Nov. 19, 2026

(54) Dynamic Minislot Scheduling per Cable Modem

(71) Applicant: Harmonic, Inc., San Jose, CA (US)

(72) Inventor: Michael Shapirshtein, Haifa (IL)

(73) Assignee: Harmonic, Inc., San Jose, CA (US)

(21) Appl. No.: 19/679,295

(22) Filed: May 15, 2026

Related U.S. Application Data
(60) Provisional application No. 63/807,851, filed on May 18, 2025.

(51) Int. Cl. H04L 12/28; H04L 5/00

(52) U.S. Cl. CPC H04L 12/2801; H04L 5/0007

(57) ABSTRACT

Dynamic scheduling of minislot resources of an Orthogonal Frequency-Division Multiplexing Access (OFDMA) upstream channel minislots using a Data Over Cable Service Interface Specification modulation profile. Conditions of the OFDMA upstream channel are probed to obtain probing samples for a particular cable modem. The probing samples comprise data indicative of channel conditions associated with upstream transmissions from the particular cable modem. Bypass channel minislots are identified, for each of one or more modulation profiles, based on the probing samples without modifying a configuration of the modulation profiles. A set of channel minislots is scheduled for the particular cable modem on the channel using a selected modulation profile. The bypass channel minislots are identified on a per-channel, per-cable modem, and per-profile basis. The scheduling includes selecting minislot resources associated with the selected modulation profile while purposefully not selecting for assignment to the particular cable modem any identified and relevant bypass channel minislots.

### CLAIM OF PRIORITY

This application claims priority to U.S. provisional patent application Ser. No. 63/807,851, filed on May 18, 2025, invented by Michael Shapirshtein, entitled “OFDMA Smart Channel Subcarrier Allocation per Cable Modem,” the entire contents of which are hereby incorporated by reference for all purposes as if fully set forth herein.

### FIELD OF THE INVENTION

Embodiments of the invention generally relate to dynamic scheduling based on observed conditions using a Data Over Cable Service Interface Specification (DOCSIS) modulation profile for an orthogonal frequency-division multiple access (OFDMA) channel.

### BACKGROUND

Data Over Cable Service Interface Specification (DOCSIS) is a widely used industry standard for transferring digital data over the existing cable television (CATV) infrastructure. DOCSIS version 3.1 introduced the concept of a profile for an Orthogonal Frequency-Division Multiplexing (OFDM) channel.

OFDM is a multiplexing technique in which multiple subcarriers are used to transmit data over a common transmission medium. The subcarriers may overlap in frequency while remaining substantially orthogonal to one another, such that interference between adjacent subcarriers is reduced. OFDM may provide greater spectral efficiency than prior multiplexing approaches such as frequency-division multiplexing. Orthogonal frequency-division multiple access (OFDMA) extends OFDM by allowing different users, such as different cable modems, to use different subsets of subcarriers and/or time intervals within a common channel.

A Cable Modem Termination System (CMTS) may define one or more profiles for a particular OFDMA channel. A profile for an OFDMA channel may be used by a CATV operator to describe physical layer parameters used by a cable modem to receive data over that OFDM channel. For example, each profile for a particular OFDMA channel describes a different set of parameters, such as modulation order (commonly referred to as a ‘constellation’ or bit-loading value), and other parameters, which defines how data is to be exchanged between a cable modem and the CMTS for that OFDMA channel.

The DOCSIS 3.1 specification informs that up to 16 profiles may be defined for a particular OFDMA channel. Version 3.1 of the specification further provides a way to assign a group of profiles to a cable modem and recommends ways how to choose the best profile to use for exchanging data with each cable modem over a particular OFDMA channel.

By convention, each downstream profile is assigned a letter, e.g., profile A, profile B, and so on. Profile A is a common downstream profile that is assigned to each cable modem for a particular OFDMA channel, while the other downstream profiles assigned for that particular OFDMA channel may differ from cable modem to cable modem.

Each OFDMA channel has its own unique set of downstream profiles. For example, profile A on OFDMA channel 1 will be different than profile A on OFDMA channel 2.

Parameters that describe a OFDMA channel are defined in an OFDMA Channel Descriptor (OCD) message, and each profile for an OFDMA channel are defined in a Downstream Profile Descriptor (DPD) message. The OCD and DPD messages are sent to all cable modems in the CATV system on a PHY Link Channel (PLC). When a cable modem initializes, it will use profile A for a particular OFDMA channel until instructed by the CMTS to use a different profile.

The DOCSIS 3.1 specification describes how the CMTS may obtain, from a particular cable modem, information indicative of channel quality for a particular OFDMA channel. The DOCSIS 3.1 specification also provides for the CMTS to request a particular cable modem (CM) to assess a particular profile and report to the CMTS information associated with the profile, such as Signal-to-Noise Ratio (SNR), Modulation Error Ratio (MER), Forward Error Correction (FEC) statistics, or other related parameters. The CM-SP-PHY DOCSIS 3.1 specification includes an algorithm which may be used by a CMTS to select a profile for use in conjunction with a particular OFDMA channel by a particular cable modem based at least in part on such information and statistics obtained from that cable modem.

DOCSIS 3.1 further defines OFDMA for upstream transmissions from cable modems to the CMTS. OFDMA is related to OFDM but allows multiple cable modems to transmit over different sets of subcarriers and/or time intervals within a common upstream OFDMA channel. In contrast to downstream OFDMA, where a downstream profile is commonly identified by a letter, upstream OFDMA transmissions are associated with Interval Usage Codes (IUCs). The CMTS may provide an upstream grant that identifies an IUC to be used by a cable modem for upstream transmission.

For an OFDMA upstream channel, an IUC identifies a type of upstream transmission opportunity and may correspond to an OFDMA upstream profile used by a cable modem when transmitting during that upstream transmission. The OFDMA upstream profile corresponding to a particular Data IUC specify physical layer parameters for an upstream burst, such as modulation order, pilot pattern, and other parameters used by the cable modem when transmitting on the OFDMA channel.

A CMTS may define a robust Data IUC for an OFDMA channel that is usable by all cable modems assigned to the OFDMA channel. For example, Data IUC 13 may be used as a robust Data IUC. The CMTS may also define additional Data IUCs having different modulation and/or pilot pattern parameters and may assign such Data IUCs to particular cable modems or groups of cable modems according to upstream channel conditions.

During upstream scheduling, the CMTS selects an upstream transmission opportunity for a cable modem and identifies, in the upstream MAP information, the IUC to be used for that transmission. The cable modem then transmits the upstream burst using the OFDMA profile associated with the identified IUC. Accordingly, upstream OFDMA profile selection may be described in terms of selecting among Data IUCs associated with respective OFDMA profiles.

The CMTS may determine which Data IUC or OFDMA profile should be assigned to a cable modem based on information indicative of upstream channel quality, including, for example, received MER, SNR, FEC statistics, ranging information, or other upstream physical layer measurements. A more robust Data IUC may be selected for a cable modem experiencing poorer upstream channel conditions, while a higher-order modulation Data IUC may be selected for a cable modem experiencing better upstream channel conditions.

A Converged Cable Access Platform (CCAP) allows service providers to offer a variety of services, such as cable television and network access, to subscribers. For example, a CCAP typically uses the DOCSIS telecommunications standard to provide Internet access to a cable modem.

In a CCAP, the CCAP core, which is the centralized control and data plane residing at the cable headend, generates MAP messages and provides them to cable modems (CMs) to inform the CMs of upstream transmission opportunities in which the CMs are allowed to transmit in an upstream direction (that is to say, in the direction from the CM to the CCAP core). A Remote PHY device uses the same MAP messages provided by the CCAP core to configure its burst receiver with the expected burst patterns and modulations in each time slot so it can demodulate the information from the signal. The upstream transmission opportunities identified by a MAP message are expressed using upstream scheduling resources, which may include minislots. In an OFDMA channel, a minislot corresponds to a defined time-frequency resource of the OFDMA channel that can be assigned for upstream transmission.

### BRIEF DESCRIPTION OF THE DRAWINGS

FIG. 1 is a block diagram of a Converged Cable Access Platform (CCAP) platform in which an embodiment of the invention may be deployed;

FIG. 2 is a flowchart illustrating the functional steps of dynamic scheduling of channel minislots using a modulation profile in accordance with an embodiment of the invention;

FIG. 3 is a plot of probing data to illustrate how observed conditions of a channel by a cable modem may be used in accordance with an embodiment of the invention;

FIG. 4 is a plot of probing data with references to modulation profiles to illustrate channel minislots of modulation profiles may be identified to bypass in accordance with an embodiment of the invention;

FIG. 5 is an illustration of scheduled minislots for three different cable modems in accordance with an embodiment of the invention; and

FIG. 6 is an illustration of assigning an N^{th} channel minislot to a particular cable modem, of a plurality of cable modems, in accordance with an embodiment of the invention.

### DETAILED DESCRIPTION OF THE INVENTION

Embodiments are directed towards dynamic scheduling of OFDMA channel minislots of a Data Over Cable Service Interface Specification (DOCSIS) modulation profile. As used herein, a minislot resource of an OFDMA upstream channel may correspond to a time-frequency resource that may be assigned to a cable modem for upstream transmission. In the following description, for the purposes of providing a detailed explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form or discussed at a high level in order to avoid unnecessarily obscuring teachings of embodiments of the invention.

### Functional Overview

Embodiments of the invention are directed towards the dynamic scheduling of OFDMA channel minislots of a Data Over Cable Service Interface Specification (DOCSIS) modulation profile. As is well known in the art, a minislot of an OFDMA channel is an amount of time-frequency allocated to a particular cable modem during which that particular cable modem may be granted to transmit in the upstream direction over that particular channel. A DOCSIS modulation profile used in conjunction with an OFDMA channel may be referred to herein as an OFDMA modulation profile, or simply a OFDMA profile.

Embodiments of the invention operate by probing conditions of an OFDMA channel to obtain, for a particular cable modem, a plurality of probing samples. The probing samples indicate channel conditions associated with upstream transmissions from the particular cable modem over respective minislot resources of the OFDMA channel.

Based on the probing samples, a CMTS identifies, for a selected modulation profile corresponding to Data IUC, a set of one or more OFDMA channel minislots to bypass when scheduling upstream transmission opportunities for the particular cable modem. The set of one or more channel minislots identified for bypass may be collectively referred to herein as “bypass profile channel minislots.”

The bypass profile channel minislots remain among minislot resources associated with the selected modulation profile. However, when scheduling the particular cable modem on the OFDMA channel using the selected OFDMA profile, the CMTS selects, for assignment to the particular cable modem, minislot resources other than the bypass profile channel minislots, while the bypass profile channel minislots remain associated with the selected OFDMA profile. Accordingly, the CMTS generates a set of minislot assignments for the particular cable modem such that the selected minislot resources do not include the identified bypass channel minislots.

In an embodiment, identifying bypass profile channel minislots does not modify the configuration of the selected OFDMA upstream profile or the Data IUC corresponding to the selected OFDMA upstream profile. For example, the modulation order, pilot pattern, and other physical layer parameters of the selected OFDMA upstream profile remain unchanged. Rather, the identified bypass profile channel minislots are used by the CMTS during scheduling to determine whether particular minislot resources associated with the selected OFDMA upstream profile are to be selected for assignment to the particular cable modem. Thus, the bypass profile channel minislots remain part of the minislot resources associated with the selected OFDMA upstream profile, but the CMTS determines not to select those minislot resources for the particular cable modem when scheduling upstream transmission opportunities using the selected OFDMA upstream profile.

Advantageously, embodiments of the invention may improve upstream communication over an OFDMA channel by enabling a CMTS to consider channel conditions associated with upstream transmissions from a particular cable modem and apply more selective scheduling of minislot resources on an OFDMA channel using a particular OFDMA profile for this cable modem. The approaches discussed herein may allow for a CM to realize enhanced throughput, reliability, or error performance, while preserving flexibility for the CMTS in scheduling upstream transmission opportunities over a channel despite determining not to assign certain channel minislots that might otherwise be provided to that CM. Embodiments of the invention shall be described in detail below. However, before doing so, it shall be helpful to appreciate the platform and/or environment in which an embodiment of the invention may be deployed.

### Upstream and Downstream Communications in a CCAP Platform

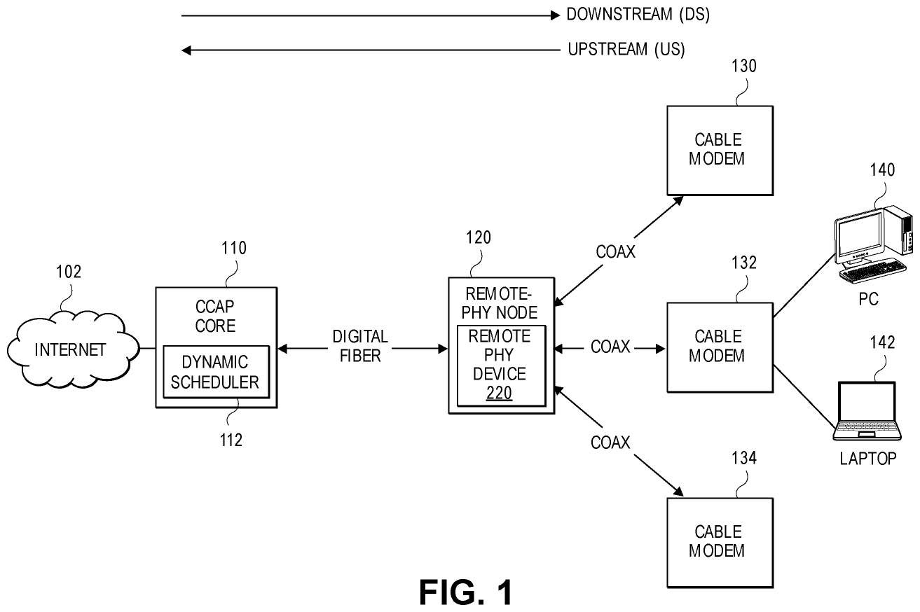

As is well-known to those in the field of cable networks, DOCSIS is a widely used industry standard for transferring digital data over the existing cable television (CATV) infrastructure, and is widely used in Converged Cable Access Platform (CCAP) deployments. CCAP is an industry standard platform for transmitting video data and voice content. FIG. 1 is a block diagram of a CCAP platform in which an embodiment of the invention may be deployed. The CCAP platform shown in FIG. 1 includes CCAP Core 110, dynamic scheduler 112, Remote PHY node 120, a plurality of cable modems 130, 132, 134, and cable subscriber network devices 140, 142. The CCAP platform shown in FIG. 1 may be implemented by a virtual CCAP platform that executes on hardware components that include a commercial off-the-shelf switch/router and one or more off-the-shelf computing servers. A commercial example of a virtual CCAP is CableOS™, available from Harmonic, Inc. of San Jose, California.

FIG. 1 depicts a downstream (DS) direction (i.e., CCAP Core 110 to cable subscribers' network devices 140, 142) and an upstream (US) direction (i.e., cable subscribers' network devices 140, 142 to CCAP Core 110). According to embodiments of the invention, DOCSIS modulation profiles may be created by, or at a location accessible to, CCAP Core 110. CCAP Core 110 may send OFDMA Channel Descriptor (OCD) messages and Downstream Profile Descriptor (DPD) messages to cable modems 130, 132, 134 to inform those cable modems of the created DOCSIS modulation profiles for an OFDMA channel. For upstream OFDMA communications, CCAP Core 110 may send Upstream Channel Descriptor (UCD) messages to cable modems 130, 132, 134 to inform those cable modems of parameters of an upstream OFDMA channel, including parameters associated with one or more OFDMA profiles and corresponding Data IUCs. CCAP Core 110 may further provide upstream MAP information identifying upstream transmission opportunities and corresponding IUCs for the upstream OFDMA channel. Cable modems 130, 132, 134 may use the downstream OFDMA profiles when receiving downstream communications from CCAP Core 110 and may use the OFDMA upstream profiles associated with corresponding Data IUCs when transmitting upstream communications to CCAP Core 110.

CCAP Core 110, as broadly used herein, refers to a CCAP Core as described in the Remote PHY family of specifications, known as the MHAv2 specifications and administrated by CableLabs® of Louisville, Colorado. CCAP Core 110 may communicate over Internet 102 (as shown in FIG. 1) or one or more private networks (not depicted in FIG. 1).

CCAP Core 110 may correspond to an integrated CCAP that performs the functions of a Cable Modem Termination System (CMTS) and an edge QAM (EQAM). Alternately, CCAP Core 110 may communicate with one or more other devices which perform functions pertaining to a CMTS and/or an EQAM.

CCAP Core 110 is typically located at a headend and is used to provide high speed data services to network devices. For example, FIG. 1 depicts two network devices 140, 142, each of which exchanges data with cable modem 132, which in turn exchanges data with CCAP Core 110 by way of Remote PHY node 120. As will be readily appreciated, a practical implementation of a CCAP platform will include many different Remote PHY nodes 120, many different cable modems, and many different network devices; however, for simplicity and ease of explanation, the large numbers of those entities are not depicted in FIG. 1.

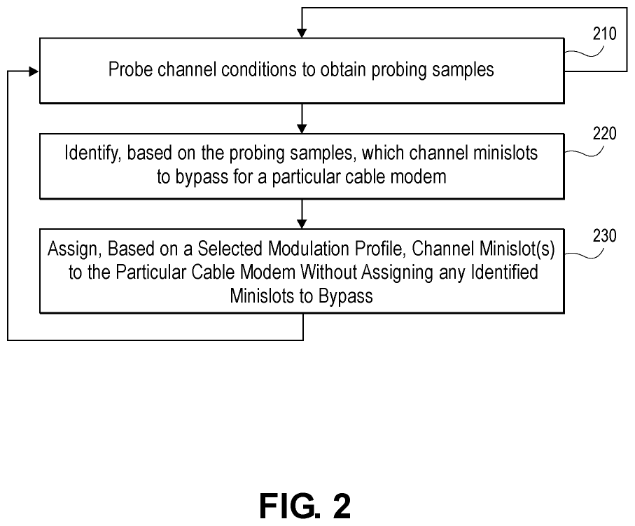

Dynamic scheduler 112, as broadly used herein, refers to software, hardware, firmware, or any combination thereof that operates to perform functions pertaining to dynamic scheduling of communications in upstream channels. In some embodiments, with respect to upstream OFDMA communications, dynamic scheduler 112 may schedule minislot resources of an OFDMA channel for one or more cable modems using one or more selected OFDMA profiles corresponding to Data IUCs. Dynamic scheduler 112 may perform one or more steps of FIG. 2, which is described below. While dynamic scheduler 112 is depicted as being part of CCAP Core 110 in the embodiment depicted in FIG. 1, in other embodiments of the invention not shown in FIG. 2, one or more functions described as being performed by dynamic scheduler 112 may be performed, in whole or in part, by a different functional entity other than CCAP Core 110.

Remote PHY node 120, with the assistance of a Remote PHY device 220 converts downstream DOCSIS data, MPEG video, and out-of-band (OOB) signals from digital to analog and upstream data, video, and OOB signals from analog to digital. A non-limiting, illustrative example of Remote PHY node 120 is the CableOS™ Ripple-1 Remote PHY node, available from Harmonic, Inc. of San Jose, California. While only a single Remote PHY node 120 is depicted in FIG. 1, practical implementations will include a large plurality of Remote PHY nodes in communication with CCAP Core 110.

Remote PHY node 120 is designed to be deployed outdoors near the physical locations of cable modems 130, 132, 134. Remote PHY node 120 is composed of an outer housing that is designed to provide a hermetically sealed environment to the interior of Remote PHY node 120 to protect internal components from outdoor environmental factors, such as humidity, water, debris, and changes in pressure. While only three DOCSIS cable modems are depicted in FIG. 1, practical implementations will have varying numbers of cable modems serviced by a particular Remote PHY node 120. For example, it is not uncommon for more than 100 cable modems to be serviced by a single Remote PHY node 120.

One such internal component enclosed by Remote PHY node 120 is a Remote PHY device 220. Remote PHY node 120 may comprise one or more Remote PHY devices 220. Remote PHY device 220 is a computerized device which performs many of the functions involved in converting downstream DOCSIS data, MPEG video, and out-of-band (OOB) signals from digital to analog and upstream data, video, and OOB signals from analog to digital. A non-limiting, illustrative example of Remote PHY device 220 is Harmonic, Inc.'s CableOS™ Pebble-1 Remote PHY device.

### Dynamic Scheduling of OFDMA Channel Minislots

FIG. 2 is a flowchart illustrating functional steps of dynamic scheduling of minislot resources of an OFDMA channel using a selected OFDMA modulation profile corresponding to a Data IUC, in accordance with an embodiment of the invention. In an embodiment, the steps of FIG. 2 may be performed by dynamic scheduler 112 to dynamically allocate one or more minislot resources of OFDMA channel for assignment to a particular cable modem, such as cable modem 130, 132, or 134.

### Obtaining Probing Samples

Initially, in step 210, dynamic scheduler 112 instructs CCAP Core 110 to probe conditions of an OFDMA channel for a particular cable modem to obtain probing samples. As used herein, the term “probing samples” refers to data, collected by CCAP Core 110, that describes conditions of the channel experienced by a particular cable modem. Probing samples may correspond to received modulation error ratio (RxMER) vectors or signal-to-noise ratio (SNR) vectors. CCAP Core 110 may obtain probing samples for an OFDMA by probing upstream (US) transmissions using a cable modem RxMER probe, which involves causing the cable modem to transmit one or more OFDMA probe signals according to probing configuration over at least a portion of the OFDMA channel spectrum. Such probes simulate read data traffic and enable CCAP Core 110 to measure the received MER/SNR per subcarrier for a particular cable modem, thus providing insight into the quality of the entire channel.

The DOCSIS 3.1 specification requires that a certain minimum average Modulation Error Ratio (MER), expressed in dB, be supported at the receiver (abbreviated as ‘RxMER’) for each channel. The MER is the ratio, in decibels, of the average symbol power to average error power. The DOCSIS 3.1 specification also requires that a certain Modulation bitload (bit per symbol)/Modulation order be supported by the receiver of each channel. To illustrate, Table 1 lists the required average RxMER as the MER thresholds per modulation order by the DOCSIS 3.1 specification.

TABLE 1

| Constellation | Carrier to Noise |
|---|---|
| (Modulation | Ratio (dB), or |
| order) | MER thresholds |
| 4096 | 41.0 |
| 2048 | 37.0 |
| 1024 | 34.0 |
| 512 | 30.5 |
| 256 | 27.0 |
| 128 | 24.0 |
| 64 | 21.0 |
| 16 | 15.0 |

As shown in Table 1, the DOCSIS 3.1 specification requires that a channel transmission sent with a modulation order of 512 to have a MER of 30.5 dB.

In an embodiment of the invention, the probing samples collected in step 210 may be filtered for invalid or bad samples or data. It should be appreciated that the particular times or intervals at or over which probing samples are collected are less important than representing the variety of channel conditions as accurately as possible.

As shown in FIG. 2, step 210 may be repeated at various intervals to obtain a new probing samples for a cable modem. At certain intervals or upon the occurrence of a particular event, such as upon receipt of an instruction to do so or upon CCAP core 110 being instructed to assign a modulation profile to a particular cable modem for a channel, processing may proceed to step 220.

### Identifying Bypass Minislots for an OFDMA Channel Profile

After CCAP core 110 probes OFDMA channel conditions to obtain probing samples for a particular cable modem for the channel, in step 220, dynamic scheduler 112 identifies, based the plurality of probing samples obtained in step 210,—a set of or one more OFDMA channel minislots to bypass for the particular cable modem and a selected OFDMA upstream profile associated with Data IUC.

Prior to discussing the performance of step 220 in detail, it will be helpful to review certain aspects about a modulation profile and its usage. An OFDMA upstream channel may be associated with a plurality of Interval Usage Codes (IUCs). Each IUC is associated with an OFDMA upstream profile used for upstream transmission on the OFDMA upstream channel. The OFDMA upstream profile corresponding to a particular IUC specifies physical layer parameters for an upstream burst, including, for example, a modulation order (e.g., 64-QAM, 1024-QAM), a pilot pattern, and one or more additional transmission parameters. Accordingly, when the CMTS schedules an upstream transmission opportunity for a cable modem using a particular Data IUC, the cable modem transmits using the OFDMA upstream profile corresponding to that Data IUC.

Different Data IUCs within the OFDMA modulation profile may therefore support different transmission characteristics for upstream transmissions on the OFDMA channel. By providing different OFDMA profiles corresponding to different Data IUCs, CCAP Core 110 may schedule more robust upstream transmission for cable modems that are experiencing poorer channel conditions and to higher-order upstream modulation transmissions for those cable modems experiencing better conditions. This approach may improve overall OFDMA channel efficiency without requiring a uniform reduction in modulation order across the entire OFDMA channel.

CCAP core 110 may establish multiple OFDMA modulation profiles for each OFDMA channel. Such profiles may be predefined, configured, or otherwise made available to CCAP Core 110. Embodiments described herein do not-require modifying the configuration of the OFDMA upstream profiles when-identifying bypass profile channel minislots.

After establishing multiple OFDMA modulation profiles for each OFDMA channel, CCAP core 110 may assign, to each cable modem, an active OFDMA modulation profile to use when communicating over that OFDMA channel. The active modulation profile assigned to a particular cable modem remains in effect until CCAP core 110 updates that assignment, as might be done by an embodiment of the invention.

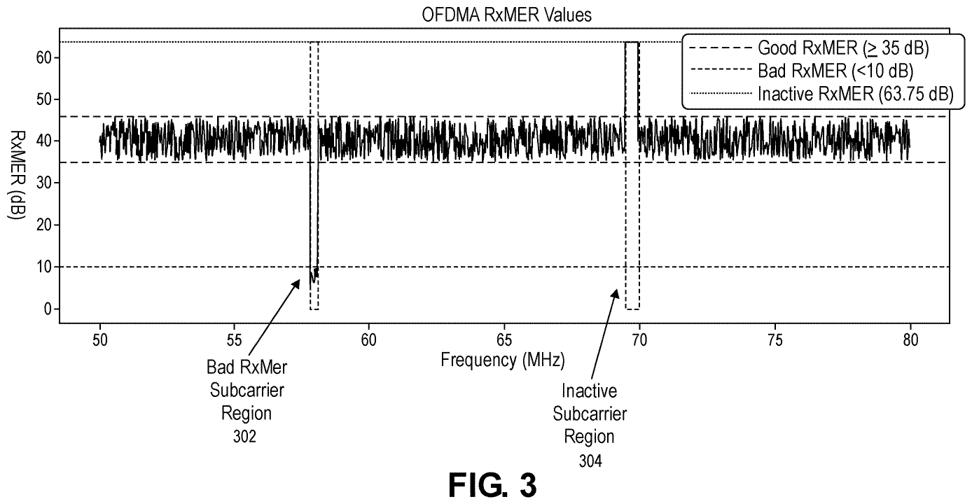

In an embodiment, in performing step 220, dynamic scheduler 112 may identify one or more OFDMA channel minislots to bypass for a particular cable modem and a selected OFDMA upstream profile associated with a Data IUC based on one or more regions of concerns in the frequency spectrum observed in the probing samples obtained in step 210 for that particular cable modem and OFDMA channel combination. To illustrate an example, consider FIG. 3, which is a plot of probing samples, obtained in step 210, for a particular cable modem over a particular channel in accordance with an embodiment of the invention.

FIG. 3 depicts frequency (MHz) over RxMER (dB) for a set of probing samples. While the majority of the probing samples shown in FIG. 3 fall within a suitable range, there are two regions of concern, namely a subcarrier region where the RxMER (dB) falls below a suitable threshold (identified on FIG. 3 as “Bad RxMER subcarrier region” 302), and a subcarrier region where there is no activity (identified on FIG. 3 as “Inactive subcarrier region” 304). In this example, subcarrier regions 302 and 304 are used to identify one or more OFDMA channel minislots to bypass for the particular cable modem when scheduling upstream transmission opportunities using the selected OFDMA profile. In particular, a minislot resource associated with a region of the OFDMA channel that does not satisfy one or more criteria for the selected OFDMA profile may be identified as a bypass profile channel minislot for the particular cable modem and the selected OFDMA profile.

### Selecting an OFDMA Upstream Profile Based on Identified Bypass Minislots

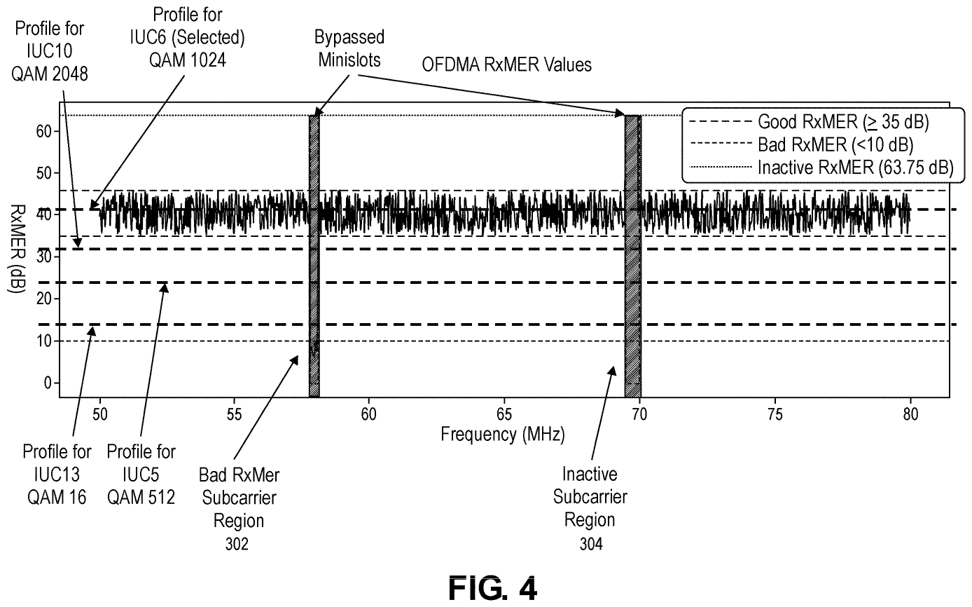

An example of how an embodiment may identify one or more channel minislots of a modulation profile to bypass, for a particular cable modem based upon problematic regions in the frequency spectrum will be explained with reference to FIG. 4, which is a plot of probing data with references to OFDMA channel modulation profiles. FIG. 4 depicts horizontal dotted lines on the plot representing thresholds (dB) of various OFDMA channel modulation profiles associated with different IUCs, namely IUC5, IUC 6, IUC 10, and IUC 13.

In the example of FIG. 4, dynamic scheduler 112 identifies, for each available OFDMA upstream profile associated with corresponding Data IUC, one or more OFDMA channel minislots to bypass based on the probing samples obtained for the particular cable modem. The identification of the one or more OFDMA channel minislots to bypass may be based on one or more channel-quality criteria, including, as shown in the example of FIG. 4, an RxMER threshold associated with the OFDMA upstream profile, or any other suitable criterion indicative of channel conditions for the particular cable modem. The OFDMA profile, together with the identified bypass profile channel minislots associated with that OFDMA profile, may then be considered as a candidate for selection as an active OFDMA profile for the particular cable modem on this OFDMA channel.

Accordingly, dynamic scheduler 112 may evaluate multiple candidate OFDMA upstream profiles for the particular cable modem, where each candidate OFDMA upstream profile is associated with a corresponding Data IUC and is associated with a corresponding set of bypass profile channel minislots. Dynamic scheduler 112 may select one of the candidates OFDMA upstream profiles based on the observed OFDMA channel conditions for the particular cable modem and the corresponding bypass profile channel minislots.

The particular algorithm, scoring function, or selection criteria used to select among the candidate OFDMA profiles is not limited by the embodiments described herein and may be implemented using any suitable profile selection technique.

In the example of FIG. 4, the OFDMA upstream profile associated with IUC 6 is selected as the active OFDMA upstream profile for the particular cable modem, together with the bypass profile channel minislots identified for that OFDMA upstream profile. The plot of FIG. 4 also depicts subcarrier regions 302 and 304, previously discussed with respect to FIG. 3.

In step 220, any OFDMA channel minislot of a modulation profile that overlaps, in whole or in part, with one or more identified regions of concern, such as any portion of subcarrier regions 302 and 304 may be identified as a bypass profile channel minislot for the particular cable modem and the corresponding modulation profile. Thus, in the example shown in FIG. 4, any minislot of any of the modulation profiles associated with IUC5, IUC 6, IUC 10, and IUC 13 which overlaps any portion of either subcarrier region 302 or subcarrier region 304 may be identified as a bypass channel minislot for the particular cable modem, such that dynamic scheduler 112 determines not to select that minislot for assignment to the particular cable modem when using the corresponding OFDMA upstream profile.

After assigning an active OFDMA upstream profile from among the candidate OFDMA upstream profiles associated with a set of one or more OFDMA channel minislots to bypass for a particular cable modem when scheduling transmission opportunities for that particular cable modem on a channel, processing proceeds to step 230 of FIG. 2.

### Assigning Transmission Opportunities Using the Bypass Channel Minislots

In an embodiment, in step 230, a set of OFDMA channel minislots (the “scheduled channel minislots”) are assigned to a particular cable modem to transmit in the upstream direction. The set of OFDMA channel minislots scheduled in step 230 may be scheduled by dynamic scheduler 112 using an OFDMA modulation profile selected for the particular cable modem. Notably, the scheduled channel minislots do not include any of the bypass channel minislots identified in step 220.

After an active OFDMA upstream profile has been selected for a particular cable modem, dynamic scheduler 112 may generate upstream minislot assignments for the particular cable modem using minislot resources associated with the active OFDMA upstream profile. In generating such minislot assignments, dynamic scheduler 112 takes into account the bypass profile channel minislots identified for the particular cable modem and the active OFDMA upstream profile. Although the bypass profile channel minislots remain among the minislot resources associated with the active OFDMA upstream profile, dynamic scheduler 112 determines not to select those bypass profile channel minislots for assignment to the particular cable modem. Dynamic scheduler 112 instead selects other minislot resources associated with the active OFDMA upstream profile to satisfy, in whole or in part, the upstream transmission opportunity for the particular cable modem.

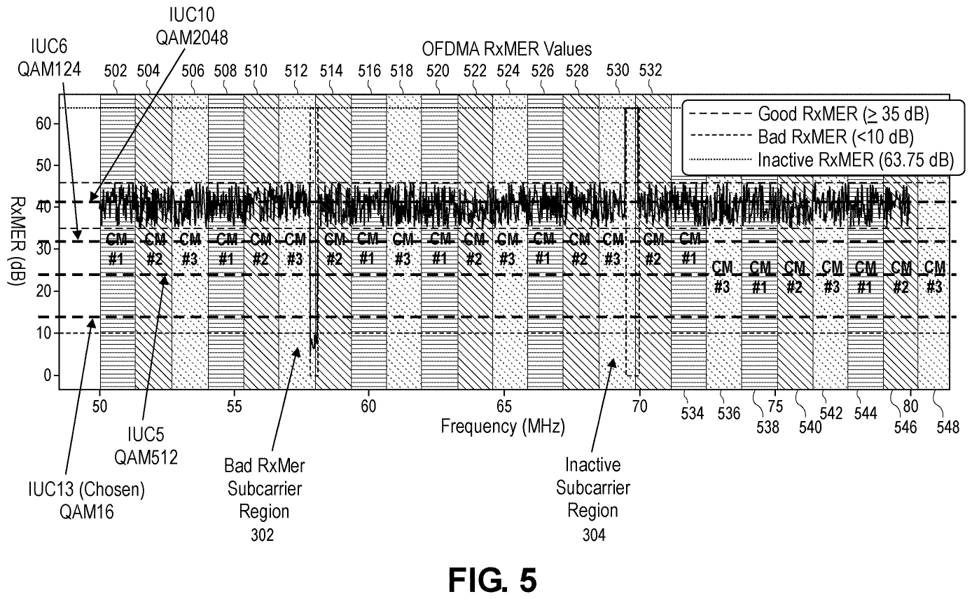

A simplified example of an embodiment upstream scheduling transmission opportunities by assigning channel minislots to a set of three cable modems during the performance of step 230 will be explained with reference to an illustration shown in FIG. 5. The example of FIG. 5 involves three cable modems, which are referenced in FIG. 5 using the notations CM #1. CM #2, and CM #3. FIG. 5 depicts probing samples, such as would be obtained in step 210, for CM #1 in a plot of frequency (MHz) vs. RxMER (dB). FIG. 5 also depicts region 302 and region 304, discussed above in an earlier example. Recall that bad RxMER subcarrier region 302 represents a portion of the frequency spectrum where, for CM #1, the RxMER (dB) falls below a suitable threshold, and recall that inactive subcarrier region 304 represents a portion of the frequency spectrum where, for CM #1, there is no active signal.

FIG. 5 depicts various modulation profiles associated with different IUCs, namely IUC5, IUC 6, IUC 10, and IUC 13. FIG. 5 also depicts minislots 502-532. Each of minislots 502-532 is depicted as being assigned to one of CM #1, CM #2, and CM #3 by dynamic scheduler 112. For example, when dynamic scheduler 112 determines upstream transmission opportunities for CM #1, CM #2, and CM #3 for a channel, dynamic scheduler 112 may select one of the four modulation profiles corresponding to IUC5, IUC 6, IUC 10, and IUC 13 for that channel, and use the selected modulation profile for that channel to assign minislots to cable modems CM #1, CM #2, and CM #3.

Note that regions 302 and 304 are relevant to CM #1, as they are based on probing samples collected from CM #1, but regions 302 and 304 are not associated with, and do not reflect, observed conditions at CM #2 or CM #3. In the example of FIG. 5, assume that there are no bypass channel minislots for CM #2 or CM #3, but by virtue of region 302 and 304, channel minislots 514 and 532 are bypass channel minislots for CM #1.

The sequential assignment described with respect to FIG. 5 is provided as one illustrative upstream scheduling policy. Other upstream scheduling policies may be used. Accordingly, embodiments of the invention are not limited to the sequential assignment of channel minislots shown in FIG. 5.

As shown in FIG. 5, dynamic scheduler 112 may attempt to assign channel minislots to each of CM #1-3 in a sequential order. In this way, dynamic scheduler 112 may attempt to assign CM #1 with the first minislot 502. Then, dynamic scheduler 112 would determine if CM #1 is associated with bypass channel minislots, and if so, whether minislot 502 is included in the set of bypass channel minislots for CM #1. In the example shown in FIG. 5, minislot 502 is not a bypass channel minislot for CM #1, and therefore dynamic scheduler 112 may proceed with assigning channel minislot 502 to CM #1. Assuming channel minislot 504-512 are each not a bypass channel minislot for any of CM #1-3, then dynamic scheduler 112 may proceed with assigning channel minislot 504-512 using any desired method for assigning minislots to cable modems, such as but not limited to sequentially. In the particular example shown in FIG. 5, dynamic scheduler 112 is employing a sequential assignment such that the next available channel minislot for a channel is assigned to the next cable modem in a sequence, which then repeats, e.g., channel minislot 502 is assigned to CM #1, then the next channel minislot 504 is assigned to the next cable modem, CM #2, and then the next channel minislot 506 is assigned to the next cable modem, CM #3, and then the next channel minislot 508 is assigned to the next cable modem, which is this case is CM #1, as there are only three cable modems being assigned to the channel and so the next cable modem in the sequence is at the top of the first for the next pass.

Note that after the assignment of channel minislot 512 to CM #3, dynamic scheduler 112 should assign the next channel minislot 514 to CM #1. However, in this example, channel minislot 514 is a bypass channel minislot for CM #1 due to the region 302 associated with CM #1. Thus, dynamic scheduler 112 assigns channel minislot 514 to CM #2 instead of CM #1. In an embodiment, when dynamic scheduler 112 bypasses an assignment of a particular channel minislot to a particular cable modem because that channel minislot is a bypass channel minislot for that cable modem, dynamic scheduler 112 attempts to schedule the next channel minislot, which is not deemed a bypass channel minislot, for that cable modem. For example, as shown in FIG. 5, as channel minislot 516 is not a bypass channel minislot for CM #1, then dynamic scheduler 112 may proceed with scheduling channel minislot 516 to CM #1, and then return to usual pattern of channel assignment with channel minislot 518, which is assigned to CM #3 as usual.

As another example, consider that channel minislot 532 is a bypass channel minislot for CM #1. Thus, rather than dynamic scheduler 112 assigning channel minislot 532 to CM #1, as per a sequential assignment pattern, dynamic scheduler 112 assigns channel minislot 532 to CM #2, and then dynamic scheduler 112 attempts to schedule the next channel minislot, which is not deemed a bypass channel minislot, for cable modem #1, which is channel minislot 534, as shown in FIG. 5.

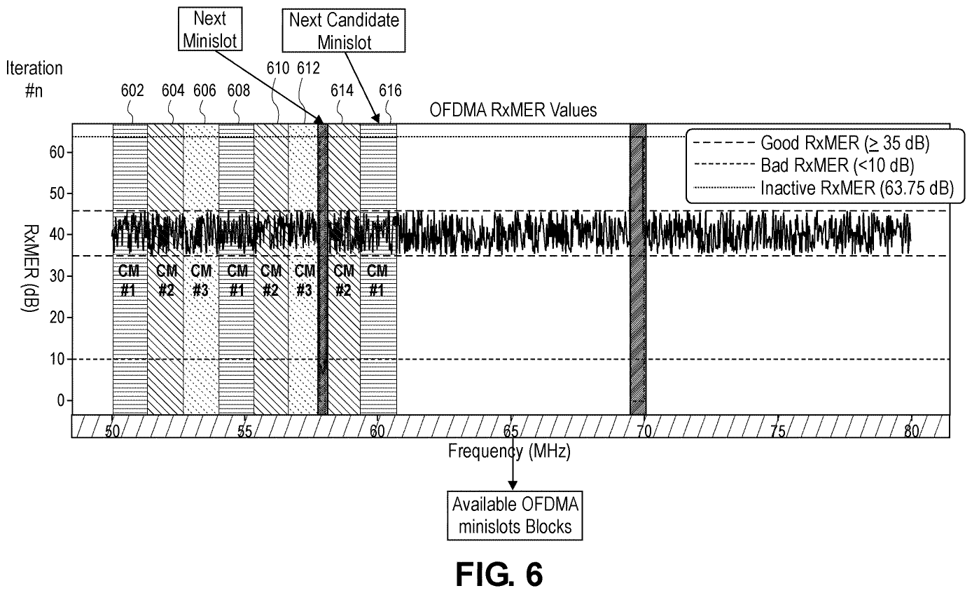

Embodiments of the invention attempt to select for each cable modem a suitable channel minislot based on its constraints as discovered in step 220. To graphically illustrate another example of this principle, consider FIG. 6, which is an illustration of assigning an N^{th} channel minislot to a particular cable modem, of a plurality of cable modems, in accordance with an embodiment of the invention. FIG. 6 depicts a sequence of channel minislots 602-616. In the example of FIG. 6, the channel minislot 614 is a bypass channel minislot for CM #1. Thus, rather than assigning channel minislot 614 to CM #1, dynamic scheduler 112 assigns channel minislot 614 to CM #2, which is the next cable modem that dynamic scheduler 112 would have assigned a channel minislot.

Advantageously, embodiments of the invention identify, on a per-cable modem basis, and per OFDMA profile basis, OFDMA channel profile minislots that should be bypassed (i.e., not scheduled) for particular cable modem based on probing samples and one or more channel-quality criteria. By taking into account the bypass profile channel minislots, dynamic scheduler 112 may evaluate-all available modulation profiles and select an active OFDMA profile for the particular cable modem for this OFDMA channel. Further, the dynamic scheduler may then schedule upstream transmission opportunities for the particular cable modem using minislot resources associated with the selected OFDMA upstream profile while determining not to select the bypass profile channel minislots for that cable modem. Advantageously, a particular channel minislot that is identified as a bypass profile channel minislot for one cable modem may not be treated in the same manner for any other cable modem. Thus, a particular channel minislots identified as a bypass profile channel minislot for particular cable modem may be may be not selected for assignment to one cable modem by dynamic scheduler 112, while being selected for assignment to another cable modem by dynamic scheduler 112.

### Extensions and Implementing Mechanisms

In an embodiment, if any OFDMA channel minislots that are not assigned to any cable modem may be handled-according to the applicable upstream scheduling policy of dynamic scheduler 112. Accordingly, embodiments of the invention are not limited to any particular default allocation or treatment of OFDMA channel minislots that are not assigned to the particular cable modem.

The term “non-transitory computer-readable storage medium” as used herein refers to any tangible medium that participates in persistently storing instructions or operational guidance which may be provided to a processor for execution. Additional details about the operation of non-transitory computer-readable storage mediums may be found within U.S. Pat. No. 11,212,590, issued Dec. 28, 2021, entitled “Multiple Core Software Forwarding,” the entire contents of which are hereby incorporated by reference for all purposes as if fully set forth herein.

In the foregoing specification, embodiments of the invention have been described with reference to numerous specific details that may vary from implementation to implementation. Thus, the sole and exclusive indicator of what is the invention and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A non-transitory computer-readable storage medium storing one or more sequences of instructions for dynamic scheduling of minislot resources of an orthogonal frequency-division multiplexing-access (OFDMA) upstream channel using a Data Over Cable Service Interface Specification (DOCSIS) modulation profile, which when executed, cause:
probing conditions of the OFDMA upstream channel to obtain a plurality of probing samples for a particular cable modem, wherein said plurality of probing samples are data that describe observed conditions of said OFDMA upstream channel by said particular cable modem;
identifying, based on said plurality of probing samples for said particular cable modem, a set of one or more bypass channel minislots for each of one or more DOCSIS modulation profiles without modifying a configuration of said one or more DOCSIS modulation profiles, and wherein said set of one or more bypass channel minislots are purposefully not selected for assignment to said particular cable modem when scheduling transmission opportunities for said particular cable modem on said OFDMA upstream channel; and
scheduling a set of channel minislots for said particular cable modem on said OFDMA upstream channel using a selected DOCSIS modulation profile, of said one or more DOCSIS modulation profiles, wherein said scheduling said set of channel minislots comprises purposely bypassing any of said set of one or more bypass channel minislots from being included in said set of channel minislots scheduled for said particular cable modem.

2. The non-transitory computer-readable storage medium of claim 1, wherein said selected DOCSIS modulation profile corresponds to a Data Interval Usage Code (IUC) identified in upstream MAP information used to schedule an upstream transmission opportunity for the particular cable modem.

3. The non-transitory computer-readable storage medium of claim 1, wherein the selected DOCSIS modulation profile corresponding to a selected Data Interval Usage Code (IUC) remains unchanged after identifying the set of one or more bypass channel minislots, and wherein the set of one or more bypass channel minislots is used by a dynamic scheduler when selecting the minislot resources for assignment to said particular cable modem.

4. The non-transitory computer-readable storage medium of claim 1, wherein said plurality of probing samples comprise one or more of received Modulation Error Ratio (RxMER) samples and Signal-to-Noise Ratio (SNR) samples for said particular cable modem over said OFDMA upstream channel.

5. The non-transitory computer-readable storage medium of claim 1, wherein said particular cable modem is a first cable modem, wherein execution of the one or more sequences of instructions further causes:
scheduling a second set of channel minislots for a second cable modem on said OFDMA upstream channel using said selected DOCSIS modulation profile, wherein said scheduling said second set of channel minislots comprises at least one of said bypass channel minislots identified for said first cable modem and said selected DOCSIS modulation profile.

6. The non-transitory computer-readable storage medium of claim 1, wherein execution of the one or more sequences of instructions further causes:
allocating any channel minislots for said OFDMA upstream channel which are not assigned to said particular cable modem according to an upstream allocation policy.

7. The non-transitory computer-readable storage medium of claim 1, wherein said probing conditions, said identifying said set of one or more bypass channel minislots, and said scheduling said set of channel minislots are each performed by a dynamic scheduler residing at, or accessible, to a Converged Cable Access Platform (CCAP).

8. The non-transitory computer-readable storage medium of claim 1, wherein the selected DOCSIS modulation profile is selected from among a plurality of candidate DOCSIS modulation profiles, each candidate DOCSIS modulation profile corresponding to a respective Data IUC and being associated with a corresponding set of bypass channel minislots identified for said particular cable modem.

9. The non-transitory computer-readable storage medium of claim 8, wherein a first candidate DOCSIS modulation profile for said particular cable modem is associated with a first set of bypass channel minislots and a second candidate DOCSIS modulation profile for said particular cable modem is associated with a second set of bypass channel minislots different from the first set of bypass channel minislots.

10. The non-transitory computer-readable storage medium of claim 1, wherein a same OFDMA channel minislot is identified as a bypass channel minislot for a first DOCSIS modulation profile for said particular cable modem and is not identified as a bypass channel minislot for a second DOCSIS modulation profile, different from said first DOCSIS modulation profile, for said particular cable modem.

11. The non-transitory computer-readable storage medium of claim 1, wherein identifying the set of one or more bypass channel minislots comprises identifying one or more regions of concern in a frequency spectrum based on one or more channel-quality criteria.

12. The non-transitory computer-readable storage medium of claim 11, wherein the one or more channel-quality criteria comprise at least one of an RxMER threshold, an SNR threshold, FEC-related information, inactive subcarrier information, and interference information.

13. An apparatus for dynamic scheduling of minislot resources of an orthogonal frequency-division multiplexing-access (OFDMA) upstream channel using a Data Over Cable Service Interface Specification (DOCSIS) modulation profile, comprising:
one or more processors; and
one or more non-transitory computer-readable storage medium storing one or more sequences of instructions, which when executed by the one or more processors, cause:
probing conditions of the OFDMA upstream channel to obtain a plurality of probing samples for a particular cable modem, wherein said plurality of probing samples are data that describe observed conditions of said OFDMA upstream channel by said particular cable modem;
identifying, based on said plurality of probing samples for said particular cable modem, a set of one or more bypass channel minislots for each of one or more DOCSIS modulation profiles without modifying a configuration of said one or more DOCSIS modulation profiles, and wherein said set of one or more bypass channel minislots are purposefully not selected for assignment to said particular cable modem when scheduling transmission opportunities for said particular cable modem on said OFDMA upstream channel; and
scheduling a set of channel minislots for said particular cable modem on said OFDMA upstream channel using a selected DOCSIS modulation profile, of said one or more DOCSIS modulation profiles, wherein said scheduling said set of channel minislots comprises purposely bypassing any of said set of one or more bypass channel minislots from being included in said set of channel minislots scheduled for said particular cable modem.

14. The apparatus of claim 13, wherein said selected DOCSIS modulation profile corresponds to a Data Interval Usage Code (IUC) identified in upstream MAP information used to schedule an upstream transmission opportunity for the particular cable modem.

15. The apparatus of claim 13, wherein the selected DOCSIS modulation profile corresponding to a selected Data Interval Usage Code (IUC) remains unchanged after identifying the set of one or more bypass channel minislots, and wherein the set of one or more bypass channel minislots is used by a dynamic scheduler when selecting the minislot resources for assignment to said particular cable modem.

16. The apparatus of claim 13, wherein said plurality of probing samples comprise one or more of received Modulation Error Ratio (RxMER) samples and Signal-to-Noise Ratio (SNR) samples for said particular cable modem over said OFDMA upstream channel.

17. The apparatus of claim 13, wherein said particular cable modem is a first cable modem, wherein execution of the one or more sequences of instructions further causes:
scheduling a second set of channel minislots for a second cable modem on said OFDMA upstream channel using said selected DOCSIS modulation profile, wherein said scheduling said second set of channel minislots comprises at least one of said bypass channel minislots identified for said first cable modem and said selected DOCSIS modulation profile.

18. The apparatus of claim 13, wherein execution of the one or more sequences of instructions further causes:
allocating any channel minislots for said OFDMA upstream channel which are not assigned to said particular cable modem according to an upstream allocation policy.

19. The apparatus of claim 13, wherein said probing conditions, said identifying said set of one or more bypass channel minislots, and said scheduling said set of channel minislots are each performed by a dynamic scheduler residing at, or accessible, to a Converged Cable Access Platform (CCAP).

20. The apparatus of claim 13, wherein the selected DOCSIS modulation profile is selected from among a plurality of candidate DOCSIS modulation profiles, each candidate DOCSIS modulation profile corresponding to a respective Data IUC and being associated with a corresponding set of bypass channel minislots identified for said particular cable modem.

21. The apparatus of claim 20, wherein a first candidate DOCSIS modulation profile for said particular cable modem is associated with a first set of bypass channel minislots and a second candidate DOCSIS modulation profile for said particular cable modem is associated with a second set of bypass channel minislots different from the first set of bypass channel minislots.

22. The apparatus of claim 13, wherein a same OFDMA channel minislot is identified as a bypass channel minislot for a first DOCSIS modulation profile for said particular cable modem and is not identified as a bypass channel minislot for a second DOCSIS modulation profile, different from said first DOCSIS modulation profile, for said particular cable modem.

23. The apparatus of claim 13, wherein identifying the set of one or more bypass channel minislots comprises identifying one or more regions of concern in a frequency spectrum based on one or more channel-quality criteria.

24. The apparatus of claim 23, wherein the one or more channel-quality criteria comprise at least one of an RxMER threshold, an SNR threshold, FEC-related information, inactive subcarrier information, and interference information.

25. A method for dynamic scheduling of minislot resources of an orthogonal frequency-division multiplexing-access (OFDMA) upstream channel using a Data Over Cable Service Interface Specification (DOCSIS) modulation profile, comprising:
probing conditions of the OFDMA upstream channel to obtain a plurality of probing samples for a particular cable modem, wherein said plurality of probing samples are data that describe observed conditions of said OFDMA upstream channel by said particular cable modem;
identifying, based on said plurality of probing samples for said particular cable modem, a set of one or more bypass channel minislots for each of one or more DOCSIS modulation profiles without modifying a configuration of said one or more DOCSIS modulation profiles, and wherein said set of one or more bypass channel minislots are purposefully not selected for assignment to said particular cable modem when scheduling transmission opportunities for said particular cable modem on said OFDMA upstream channel; and
scheduling a set of channel minislots for said particular cable modem on said OFDMA upstream channel using a selected DOCSIS modulation profile, of said one or more DOCSIS modulation profiles, wherein said scheduling said set of channel minislots comprises purposely bypassing any of said set of one or more bypass channel minislots from being included in said set of channel minislots scheduled for said particular cable modem.
